(19) United States
(12) Patent Application Publication
(10) Pub. No.: US 2012/0158945 A1
(43) Pub. Date: Jun. 21, 2012

(54) SERVER LOAD BALANCING USING DYNAMIC LOG-ON GROUPS

(76) Inventors: Christian Goldbach, Mannheim (DE); Matthias Rinck, Klingenmuenster (DE); Bernhard Braun, Rauenberg (DE); Florian Foebel, Buerstadt (DE); Bjoern Friedmann, Rheinmuenster (DE); Jochen Mueller, Heidelberg (DE); Werner Rehn, Heidelberg (DE); Achim Braemer, Heidelberg (DE)

(21) Appl. No.: 12/970,845

(22) Filed: Dec. 16, 2010

(51) Int. Cl. G06F 15/173

(52) U.S. Cl. 709/224; 709/223

(57) ABSTRACT

One or more dynamic logon group parameters can be retrieved. The dynamic logon group parameters can be associated with an originator of requests for server processing by a computing system that includes a plurality of server instances, can be established prior to runtime, and can include an abstract definition of server instance characteristics required or preferred for handling the requests from the originator without designating specific server instances for handling the requests from the originator. One or more server instances can be selected from the plurality of server instances such that the one or more selected server instances satisfy the abstract definition of server instance characteristics. At runtime, the one or more selected server instances can be assigned to respond to the requests from the originator. Related articles of manufacture, systems, and methods are described.

### TECHNICAL FIELD

The subject matter described herein relates to balancing of loads on a server, for example a server that includes multiple physical processors, using dynamic log-on groups to partition loads to specific physical processors or groups of physical processors.

### BACKGROUND

Load balancing can be used for scalability and resource optimization in scenarios where multiple servers, such as for example server instances, cluster nodes, and the like, are available to serve requests. Load balancing for optimal resource utilization can require distributing incoming requests as evenly as possible between available server system instances and dispatching requests with similar requirements for data usage to the same server instances as frequently as possible. These requirements can conflict and therefore complicate implementation of an optimal load balancing arrangement.

### SUMMARY

The current subject matter provides an approach to assigning multiple server instances of a software delivery architecture among multiple originators of resource requests. The incoming requests can be partitioned into groups of requests which are dynamically assigned to server instances or groups of server instances. Unlike caching of static content where an entire resource might cacheable, the use of dynamic logon groups as described herein can be applied to dynamic resources, such as for example one or more applications provided via the core software platform. Performance improvements can be achieved because dynamic resources belonging to one group of requests often need to access the same data.

In one aspect, a computer-implemented method includes retrieving at least one dynamic logon group parameter associated with an originator of requests for server processing by a computing system that includes a plurality of server instances. The at least one dynamic logon group parameter is established prior to runtime and includes an abstract definition of server instance characteristics required or preferred for handling the requests from the originator without designating specific server instances for handling the requests from the originator. At least one server instance that satisfies the abstract definition of server instance characteristics is selected from the plurality of server instances. At runtime, the at least one selected server instance is assigned to respond to the requests from the originator.

In some variations one or more of the following can optionally be included. The assigned at least one server instance can include at least two server instances of the plurality of server instances. A plurality of incoming requests from the originator can be distributed across the assigned at least two server instances. The computing system can be a part of a multi-tenant software delivery architecture and the originator can include a tenant of the multi-tenant software delivery architecture. The multi-tenant software delivery architecture can further include a data repository. The computing system can provide access for each of a plurality of organizations to one of a plurality of tenants, each which can include a customizable, organization-specific version of a core software platform. The data repository can include core software platform content that relates to the operation of the core software platform that is common to all of the plurality of tenants, system content having a system content format defined by the core software platform and containing system content data that are unique to specific tenants of the plurality of client tenants, and tenant-specific content items whose tenant-specific content formats and tenant-specific content data are defined by and available to only one of the plurality of tenants.

In further optional variations, at least one second dynamic logon group parameter associated with a second originator of second requests for server processing by the computing system can be retrieved. The at least one second dynamic logon group parameter can be established prior to runtime and can include a second abstract definition of server instance characteristics required or preferred for handling the second requests from the second originator without designating second specific server instances for handling the second requests from the second originator. At least one second server instance can be selected from the plurality of server instances. The at least one second selected server instance can satisfy the second abstract definition of server instance characteristics. At runtime, the at least one second selected server instance can be assigned to respond to the second requests from the second originator. A change in availability of one of the at least one second server instances can be detected, and one of the at least one server instances can be re-assigned to respond to the second requests of the second originator. The re-assigning can occur such that the assigned at least one server instance satisfies the abstract definition and the assigned second at least one server instance satisfies the second abstract definition.

Articles are also described that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

It should be noted that, while the descriptions of specific implementations of the current subject matter may discuss delivery of enterprise resource planning software to one or more organizations, in some implementations via a multi-tenant system, the current subject matter is applicable to other types of software and data services access as well. Also, it should be noted that various figures and descriptions provided throughout this disclosure may for illustrative purposes show a specific number of server instances or other features of an implementation of the current subject matter. These examples are not meant to be limiting unless explicitly so stated in the foregoing description. The scope of the subject matter claimed below therefore should not be limited except by the actual language of the claims.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram showing features relating to a computing architecture in which load balancing is applied;

FIG. 2 is a diagram showing features relating to another computing architecture in which load balancing is applied;

FIG. 3 is a diagram showing features relating to an implementation of a multi-tenant computing architecture;

FIG. 4 is a diagram showing features relating to storage of tenant dependent and tenant independent data and data objects in a multi-tenant computing architecture;

FIG. 5 shows a table listing parameters of static and dynamic logon groups;

FIG. 6 shows another table listing parameters of static and dynamic logon groups; and

FIG. 7 is a process flow diagram illustrating aspects of a method consistent with implementations of the current subject matter.

When practical, similar reference numbers denote similar structures, features, or elements.

### DETAILED DESCRIPTION

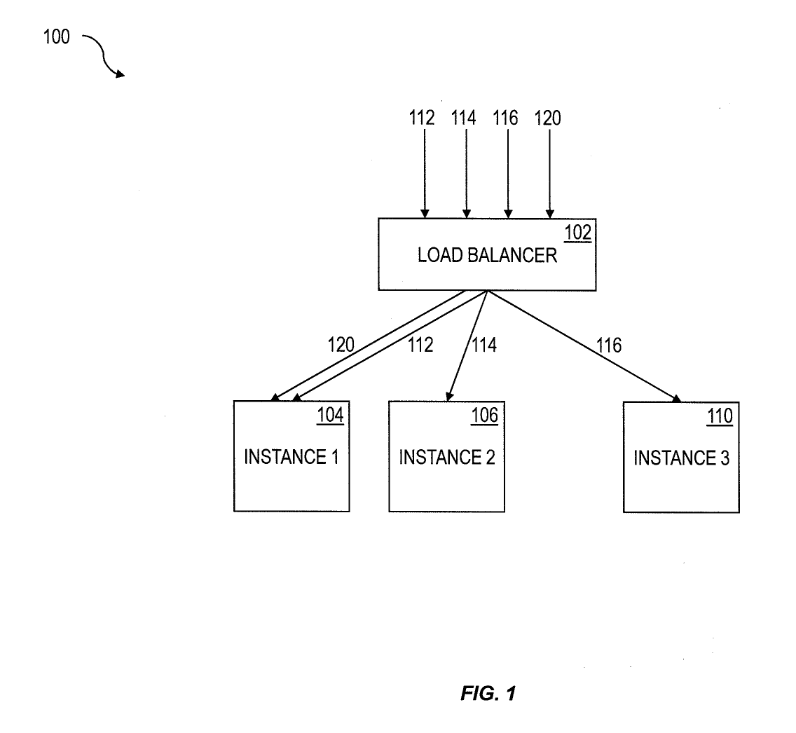

Load Balancing in a server scenario enables horizontal scaling (also referred to as “scaling out”) whereby a load balancer can distribute server task loads among multiple server instances. In a non-limiting example, HTTP/HTTPS load balancing can be used in Web server scenarios. Load balancers can use different strategies to balance tasks loads (or “loads”) among multiple backend servers. One non-limiting example of load balancing involves use of a round-robin strategy by a Web server or the like to evenly distribute incoming load requests among the backend servers, for example as illustrated in the diagram 100 of FIG. 1. As shown in FIG. 1, a load balancer 102, which can be a Web dispatcher, distributes loads among three server instances 104, 106, 110 according to a round robin load balancing technique in which a first incoming request 112 is directed to the first instance 104, a second incoming request 114 is directed to the second instance 106, and a third incoming request 116 is directed to the third instance 110. As there are three server instances, a fourth incoming request 120 is again directed to the first instance 104, and so forth. However, in this approach, no consideration is given to directing requests that are likely to require access to similar data to the same server instance or group of server instances.

An alternative approach to load balancing among a number of server instances is to use logon groups to bundle specific HTTP/HTTPS requests or other server requests to one or more servers among all available servers. Logon groups can in some examples be defined by an URL prefix and a logon group name designating a group of server instances. While load balancing distributes load among different servers, log-on groups act in an opposite manner to allow specific requests to be bundled to one or more sub groups of server instances among all available server instances. In one example, graphical user interface requests for an enterprise resource management (ERM) system can be distributed across available server instances of the ERM system in a manner that directs requests that are likely to require access to similar data to a limited set or logon group of server instances. In this manner, the cache memory on each server instance can be more effectively utilized.

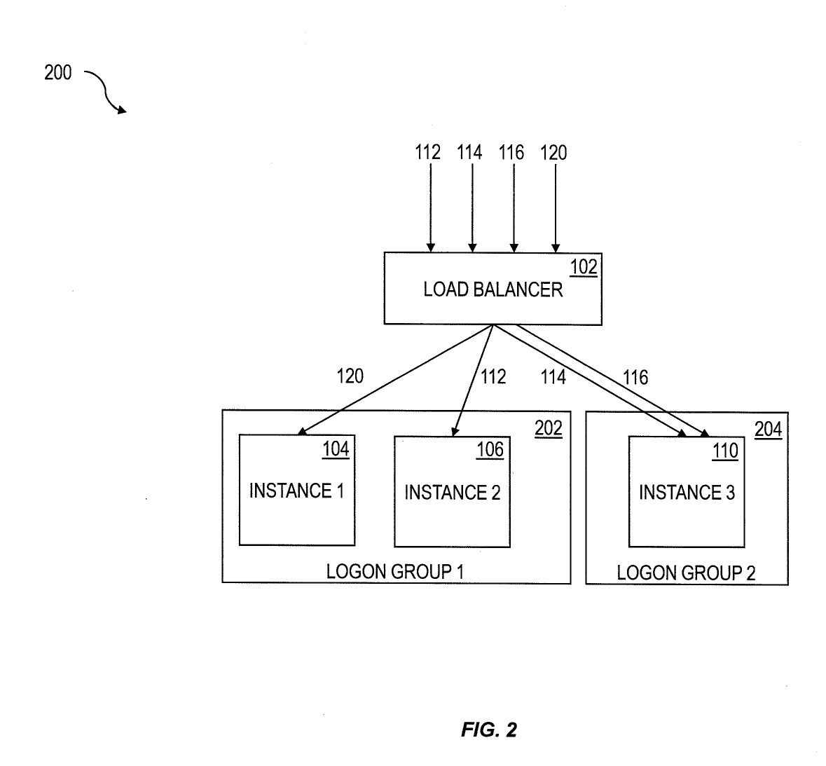

As shown in FIG. 2, a load balancer 102, which can be a Web dispatcher, distributes loads among three server instances 104, 106, 110 according to which logon group each server instance belongs. In the example of FIG. 2, a first, static logon group 202 includes the first server instance 104 and the second server instance 106 while a second, static logon group 204 includes the third server instance 204. The servers instances in a logon group can be designated to handle requests for data or services that are assigned to that logon group. For example, in the example of FIG. 1 discussed above, the first incoming request 112 and fourth incoming request 120 can have a URL prefix and/or a logon name designating the first logon group 202 while the second incoming request 114 and the third incoming request 116 have a URL prefix and/or a logon name designating the second logon group 204. In this example, the first incoming request 114 and the third incoming request 116 are directed to the third server instance 110 as it is the only server instance assigned to the second logon group 204. The first incoming request 112 and the fourth incoming request 120 are divided between the first server instance 104 and the second server instance 106. This arrangement therefore results in twice as many incoming requests being handled by the third server instance relative to each of the first server instance 104 and the second server instance 106. As such, use of static logon groups can be at odds with efforts to balance server loads evenly across multiple server instances.

To address these and potentially other issues with currently available solutions, one or more implementations of the current subject matter provide methods, systems, articles or manufacture, and the like that can, among other possible advantages, provide dynamic logon group support to a load balancer to enabling the dynamic assignment of server instances to logon groups.

In one implementation of the current subject matter, dynamic logon groups can be used to balance server loads across multiple server instances in a software delivery architecture for requests generated by tenants in a multi-tenant (virtual hosting) environment as is described below. Requests generated by a same tenant can be directed to a sub-group of the available server instances. Such an approach is not limited to multi-tenant environments, and can be extended to other architectures and configurations in which server load requests can be binned into groups of requests needing access to the same or similar data.

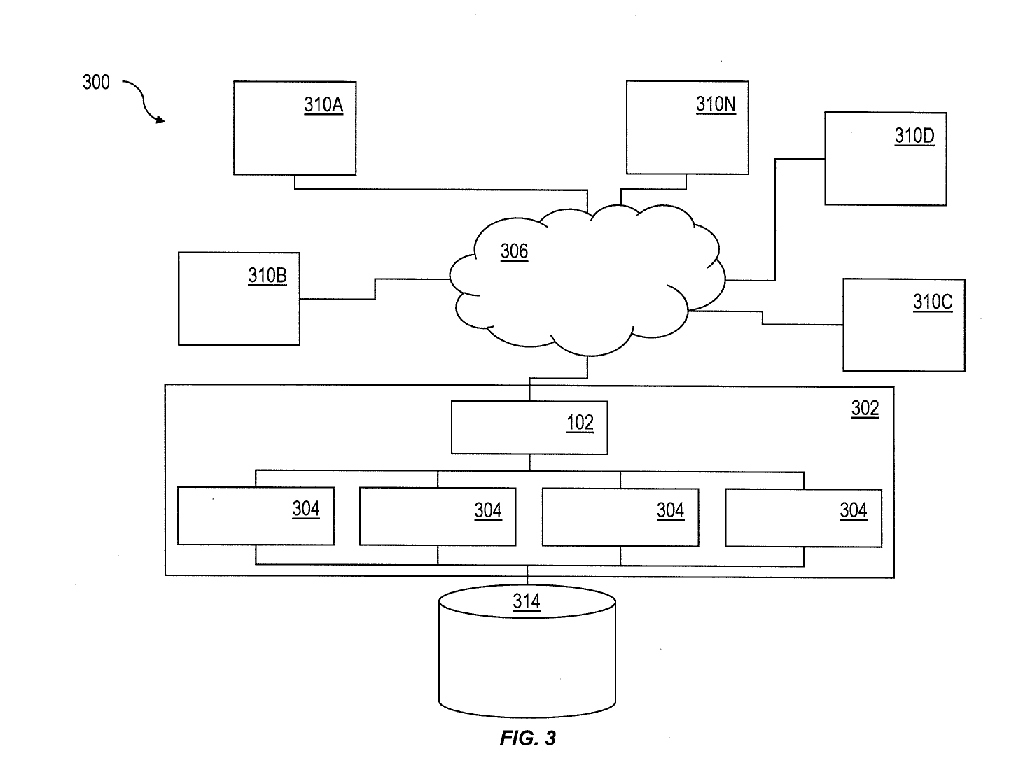

FIG. 3 shows a block diagram of a multi-tenant implementation of a software delivery architecture 300 that includes an application server 302, which can include multiple server instances 304 that are accessible via a load balancer 102 that distributes requests received over a network 306 from client machines operated by users at each of multiple organizations 310A-310E (referred to herein as “tenants” of a multi-tenant computing system), each of which is provided a customized version of a core software platform via supported by the single software delivery architecture 300. The software delivery architecture 300 shows an example with five tenants 310A-310E and four server instances 304. However, the configuration shown is presented as an illustrative example only. Other configurations having nearly any combination of server instances 304 and tenants 310 is possible.

The application server can include a load balancer 102 to distribute requests and actions from users at the one or more organizations represented by tenants 310A-310E to the one or more server systems 304. A user can access the software delivery architecture across the network 306 using a thin client, such as for example a web browser or the like, or other portal software running on a client machine. The server instances 304 of the application server 302 can access data and data objects stored in one or more data repositories 314.

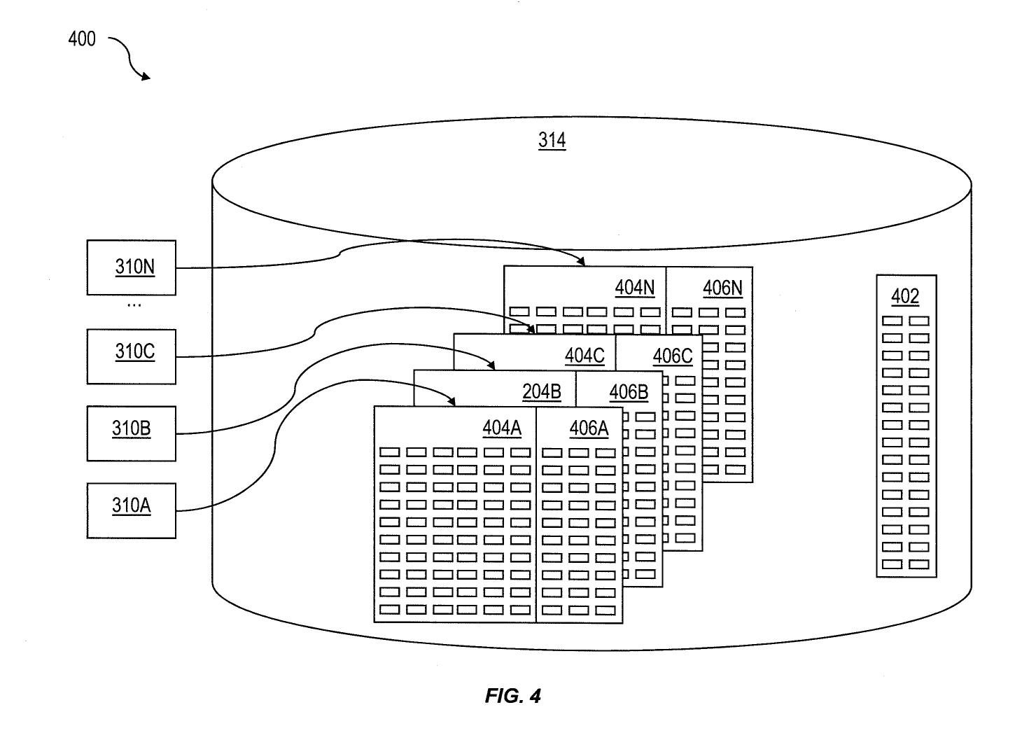

To provide for customization of the core software platform for each of multiple organizations supported by a single software delivery architecture 300, the data and data objects stored in the repository or repositories 314 that are accessed by the server instances 102 of the application server 302 can include three types of content as shown in FIG. 4: core software platform content 402, system content 404, and tenant content 406. Core software platform content 402 includes content that represents core functionality and is not modifiable by a tenant. System content 404 can in some examples be created by the runtime of the core software platform and can include core data objects that are modifiable with data provided by each tenant. For example, if the core software platform is an enterprise resource planning (ERP) system that includes inventory tracking functionality, the system content 404A-404N can include data objects for labeling and quantifying inventory. The data retained in these data objects are tenant-specific, for example, each tenant 310A-310N stores information about its own inventory.

Tenant content 406A-406N can include data objects or extensions to other data objects that are customized for one specific tenant 310A-310N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 406 can include condition records in generated condition tables, access sequences, price calculation results, or any other tenant-specific values. A combination of the software platform content 402 and system content 404 and tenant content 406 of a specific tenant are presented to users from that tenant such that each tenant is provided access to a customized solution having data that is available only to users from that tenant. Use of the letter N in FIG. 4 is intended to denote any number of tenants 310 and associated system content 404 and tenant content 406.

A multi tenancy approach such as that shown in FIG. 3 and FIG. 4 and described above can reduce the cost of operations both to a customer and to the SaaS provider. Cost reductions can be achieved in some examples through resource sharing, more precisely by sharing among multiple tenants a central system or software delivery architecture 300 that includes the database 314, multiple server instances 304, and the like. In an example in which a multi-tenant system is implemented using HTTP/HTTPS processing, tenants 310 can be instantiated as virtual hosts, each using a different hostname (e.g. lego.core-platform.com, brio.core-platform.com, etc.) to access applications for each different tenant 310 on a single software delivery architecture using a load balancer 102. To support a multi-tenancy approach as described, a logon group definition can include both a designation of a tenant 310 (virtual host) and a URL prefix. The criteria for a request to indicate a logon group can be one or more of the URL prefix, the virtual host, the virtual host plus URL prefix, or some other identification of a logon group.

In an illustrative example of optimizing a distribution of processing loads among multiple available server instances 304, a software delivery system 300 provides access to five tenants 310A-310E, a first of which 310A generates a load equivalent to that of the other four tenants 310B-310E combined. The software delivery system 300 includes four server instances 304 each having 4 GB of cache memory usable for caches. If each tenant 310A-310E has only one assigned server instance 304, then one of the server instances 304 (the one assigned to the tenant 310A that generates the large server load) has a load four times higher than the other server instances 304. However, if two of the server instances 304 are dedicated to the large tenant 310A, two small tenants 310B and 310C use a third server instance 304, and the other two small tenants 310D and 310E use the fourth server instance 304, then the load is evenly distributed among the four server instances 304. Load distribution can be optimized by balancing requests for the large load tenant 310A between the two server instances 304 that are assigned to it.

In another illustrative example of optimizing cache usage on multiple server instances 304 or other hardware resources to which requests are distributed by a load balancer 102, requests which require access to similar data can be processed on the same server instance 304. A software delivery system that provides access to four tenants 310A-310D can include four server instances 304 each having 4 GB of cache memory usable for caches. Assuming for illustrative purposes that the data accessed by each of the tenants 310A to 310D is strictly disjoint (i.e. there is no overlap of data accessed by a first tenant and a second tenant), if one dedicated server instance 304 is used per tenant 310, then each server instance 304 is able to cache data for its corresponding tenant 310A, 310B, 310C, or 310D. In other words, one server instance 304 caches 4 GB of data for one single tenant 310A, 310B, 310C, or 310D. However, if requests for all of the four tenants 310A-310D are processed on all server instances 304, then each server instance 304 might instead cache data for each of the tenants 310A-310D. For example, each server instance 304 can cache 1 GB of data for each tenant 310A-310D. In a worst case scenario in which four requests from a first tenant 310A that each use similar data are distributed in a round robin load balancing method, the same 1 GB of data can be cached on each server instance 304 for that tenant 310A.

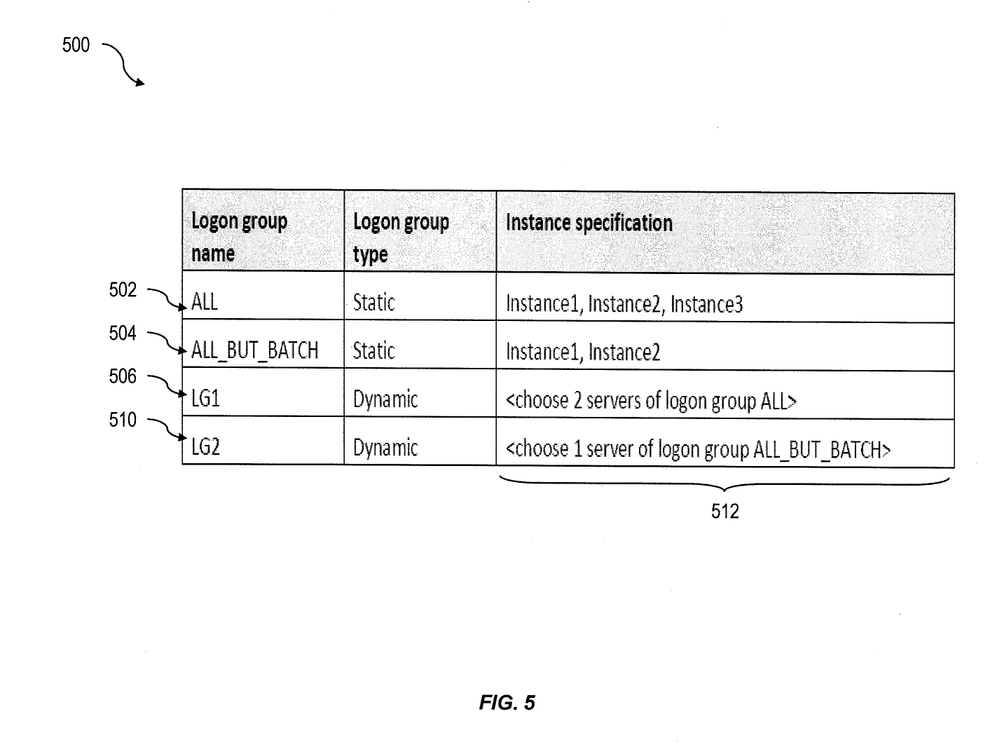

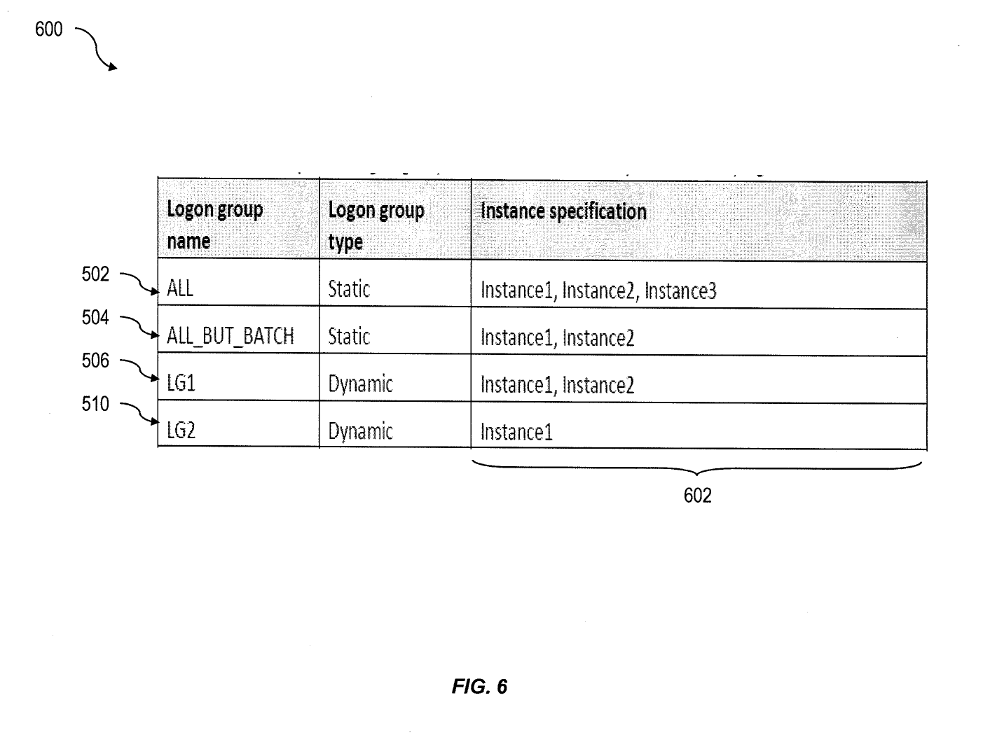

Overall resource use optimization can be maximized according to implementations of the current subject matter by basing the assignment of requests to server instances 304 via the load balancer 102 in a manner that reflects the actual loads and memory demands of the multiple tenants 310 provided by a software delivery architecture 300. Dynamic determination of cache utilization and request distribution by using dynamic logon groups consistent with the implementations described herein can be performed in some implementations as follows. Instead of assigning one or more fixed server instances to a static logon group, for example as shown in FIG. 2, the server specification in a dynamic logon group can be dynamic and can specify abstract attributes of a logon group. As an illustrative, non-limiting example, these abstract attributes can include one or more of a maximum number of server instances to be dedicated to requests by users of tenants in the logon group, a reference (static) logon group containing the candidate server instances to be assigned to the dynamic logon group, and the like. FIG. 5 shows an example of a table 500 listing logon group definitions for an example including two static logon groups 502, 504 and two dynamic logon groups 506, 510. The load balancer 102 can choose the server instances 304 to be assigned to each dynamic logon group from the server instance candidate listings 512 in the static logon group definitions. At runtime, the dynamic logon groups can be instantiated with specific server instances 304, for example as indicated by instance specifications 602 in a table such as table 600 shown in FIG. 6.

The dynamic assignment of server instances 304 can take into account the actual load of each tenant 310 at run time and can be capable of reacting to failure of specific server instances 304, while a static logon group with only one assigned server instance 304 would fail to find a server instance 304 in case of a failure of a server instance 304. Furthermore, instead of specifying a predetermined list of server instances 304 in a logon group, a dynamic logon group can specify only the maximum number of server instances to be used for a defined set of requests, or alternatively a minimum number of server instances, both a maximum and a minimum, a target range, or the like. At runtime, the load balancer 102 can determine which specific server instances 304 to actually include in the logon group based on the current loads on the software delivery architecture 300. In one example, the server instances 304 for each logon group can be chosen from the set of all available server instances 304.

Any load balancing mechanism can be used for choosing a specific server instance 304 to be included into a dynamic logon group. For example, the server instance 304 that has received the smallest number of requests in the past can be chosen for a logon group with the highest load. In some implementations, the requests belonging to one dynamic logon group can be defined by a URL prefix, by the virtual host of the tenant, by a combination of the virtual host plus the URL prefix, or by some other identifier. Alternatively or in addition, the requests belonging to one dynamic logon group can be any other criterion, or any other combination of criteria that facilitates grouping of incoming requests.

In some variations, rather than choosing the server instances to be used for a dynamic logon group from the set of all available instances, the server instances for a given dynamic logon group can be chosen from a provided “static” logon group, for example as indicated by server instance candidate listings 512 such as is shown in the table 500 of FIG. 5. Alternatively or in addition, instead of choosing the specified number of instances dynamically, the number of instances specified can be interpreted as a maximum and/or a minimum value for the number of server instances allowed. At runtime, the load balancer 102 can know the actual load per logon group. It can then assign the maximum specified number of server instances 304 to those logon groups in which the load is high or expected to be high, and assign less than the maximum specified number of server instances 304 to those logon groups in which the load is low or expected to be low. In this manner, the load balancer 102 can assign instances according to the actual, current load for each logon group. As noted above, in addition to the maximum number of server instances 304 in a dynamic logon group, a minimum number of server instances 304 can optionally also be specified. In the event of a failure or other removal from productive service or non-availability of one or more server instances 304 assigned to a dynamic logon group, the load balancer 102 can reassign server instances 304 among the dynamic logon groups. The load balancer 102 can also reassign server instances 304 to a dynamic logon group during operation of the software delivery architecture 300, for example when the loads are unevenly distributed among the server instances 304. While reassigning server instances 304 can temporarily eliminate the benefits of cache optimization, such action can be desirable if the loads are significantly out of balance among the available server instances 304. Reassignment of server instances 304 can involve a tradeoff between maintaining an the assignment in order to maintain an optimized cache utilization and revoking the assignment in order to better optimize load distribution.

As an alternative to the load balancer 102 determining the server instances 304 to be assigned to a dynamic logon group at run time, a backend system can determine the server instances 304 contained in one or more of the dynamic logon groups at run time. The backend system can also have metrics that can be used to define how load balancing should be performed. The load balancer 102 can pull dynamic logon group configuration information periodically, for example by sending HTTP requests for configuration retrieval to the backend system, or upon detection of one or more threshold criteria, etc. The backend system can optionally publish the dynamic logon group definition by actively sending the configuration to the load balancer 102 using a persistent network connection between the load balancer 102 and the backend system.

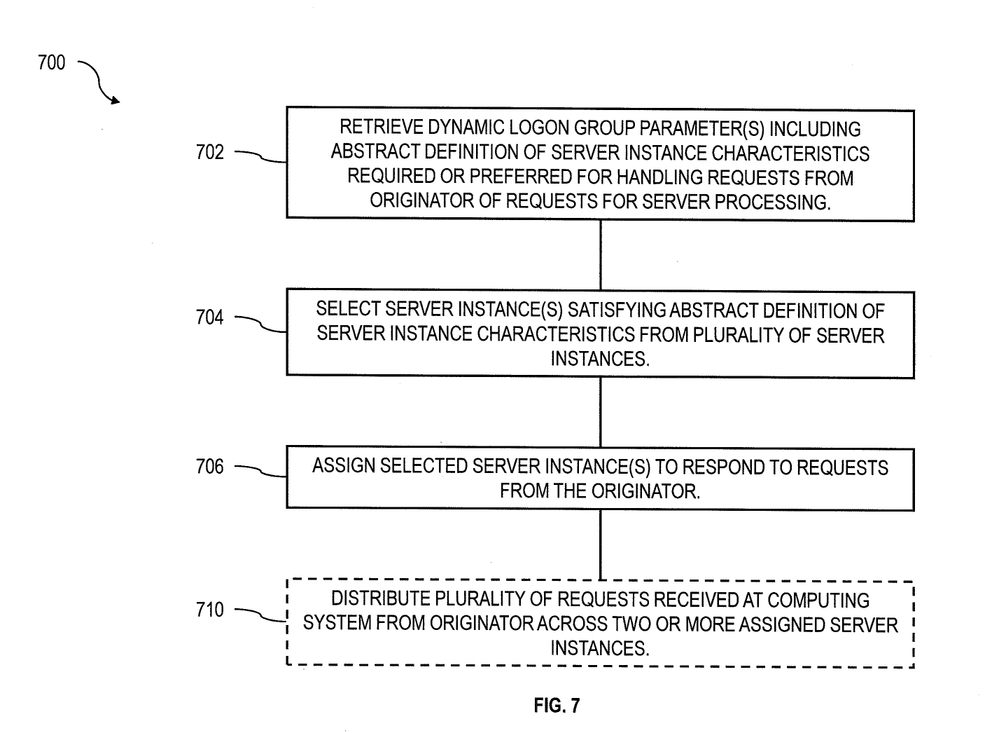

FIG. 7 shows a process flow chart 700 illustrating aspects of a method consistent with the current subject matter. At 702, one or more dynamic logon group parameters associated with an originator of requests for server processing by a computing system can be retrieved. The computing system includes a plurality of server instances. The one or more dynamic logon group parameters can have been established prior to runtime and can include an abstract definition of server instance characteristics required or preferred for handling the requests from the originator without designating specific server instances for handling the requests from the originator. At 704, one or more server instances can be selected from the plurality of server instances such that the one or more selected server instances satisfy the abstract definition of server instance characteristics. At 706, the one or more selected server instances can be assigned at runtime to respond to the requests received at the computing system from the originator. An originator can be any client or other computing system that produces server requests, potentially including, but not limited to, a tenant of a multi-tenant computing architecture as described above. Optionally, if the one or more server instances include at least two server instances of the plurality of server instances, a plurality of incoming requests from the originator can be distributed across the two or more assigned server instances at 710.

The subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. A client and server are generally, but not exclusively, remote from each other and typically interact through a communication network, although the components of the system can be interconnected by any form or medium of digital data communication. Examples of communication networks include, but are not limited to, a local area network (“LAN”), a wide area network (“WAN”), and the Internet. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed:

1. A computer program product comprising a machine-readable medium storing instructions that, when executed by at least one programmable processor, cause the at least one programmable processor to perform operations comprising:
retrieving at least one dynamic logon group parameter associated with an originator of requests for server processing by a computing system comprising a plurality of server instances, the at least one dynamic logon group parameter being established prior to runtime and comprising an abstract definition of server instance characteristics required or preferred for handling the requests from the originator without designating specific server instances for handling the requests from the originator;
selecting at least one server instance from the plurality of server instances, the at least one selected server instance satisfying the abstract definition of server instance characteristics;
assigning, at runtime, the at least one selected server instance to respond to the requests from the originator.

2. A computer program product as in claim 1, wherein the assigned at least one server instance comprises at least two server instances of the plurality of server instances, and wherein operations further comprise distributing a plurality of incoming requests from the originator across the assigned at least two server instances.

3. A computer program product as in claim 1, wherein the computing system is part of a multi-tenant software delivery architecture and the originator comprises a tenant of the multi-tenant software delivery architecture.

4. A computer program product as in claim 3, wherein the multi-tenant software delivery architecture further comprises a data repository, and wherein the computing system provides access for each of a plurality of organizations to one of a plurality of tenants, each of the plurality of tenants comprising a customizable, organization-specific version of a core software platform, the data repository comprising core software platform content that relates to the operation of the core software platform that is common to all of the plurality of tenants, system content having a system content format defined by the core software platform and containing system content data that are unique to specific tenants of the plurality of client tenants, and tenant-specific content items whose tenant-specific content formats and tenant-specific content data are defined by and available to only one of the plurality of tenants.

5. A computer program product as in claim 1, wherein the operations further comprise:
retrieving at least one second dynamic logon group parameter associated with a second originator of second requests for server processing by the computing system, the at least one second dynamic logon group parameter being established prior to runtime and comprising a second abstract definition of server instance characteristics required or preferred for handling the second requests from the second originator without designating second specific server instances for handling the second requests from the second originator;
selecting at least one second server instance from the plurality of server instances, the at least one second selected server instance satisfying the second abstract definition of server instance characteristics;
assigning, at runtime, the at least one second selected server instance to respond to the second requests from the second originator.

6. A computer program product as in claim 5, wherein the operations further comprise:
detecting a change in availability of one of the at least one second server instances; and
re-assigning one of the at least one server instances to respond to the second requests of the second originator, the re-assigning occurring such that the assigned at least one server instance satisfy the abstract definition and the assigned second at least one server instance satisfy the second abstract definition.

7. A system comprising:
at least one programmable processor; and
a machine-readable medium storing instructions that, when executed by the at least one programmable processor, cause the at least one programmable processor to perform operations comprising:
retrieving at least one dynamic logon group parameter associated with an originator of requests for server processing by a computing system comprising a plurality of server instances, the at least one dynamic logon group parameter being established prior to runtime and comprising an abstract definition of server instance characteristics required or preferred for handling the requests from the originator without designating specific server instances for handling the requests from the originator;
selecting at least one server instance from the plurality of server instances, the at least one selected server instance satisfying the abstract definition of server instance characteristics;
assigning, at runtime, the at least one selected server instance to respond to the requests from the originator.

8. A system as in claim 7, wherein the assigned at least one server instance comprises at least two server instances of the plurality of server instances, and wherein operations further comprise distributing a plurality of incoming requests from the originator across the assigned at least two server instances.

9. A system as in claim 7, wherein the computing system is part of a multi-tenant software delivery architecture and the originator comprises a tenant of the multi-tenant software delivery architecture.

10. A system as in claim 9, wherein the multi-tenant software delivery architecture further comprises a data repository, and wherein the computing system provides access for each of a plurality of organizations to one of a plurality of tenants, each of the plurality of tenants comprising a customizable, organization-specific version of a core software platform, the data repository comprising core software platform content that relates to the operation of the core software platform that is common to all of the plurality of tenants, system content having a system content format defined by the core software platform and containing system content data that are unique to specific tenants of the plurality of client tenants, and tenant-specific content items whose tenant-specific content formats and tenant-specific content data are defined by and available to only one of the plurality of tenants.

11. A system as in claim 7, wherein the operations further comprise:
retrieving at least one second dynamic logon group parameter associated with a second originator of second requests for server processing by the computing system, the at least one second dynamic logon group parameter being established prior to runtime and comprising a second abstract definition of server instance characteristics required or preferred for handling the second requests from the second originator without designating second specific server instances for handling the second requests from the second originator;
selecting at least one second server instance from the plurality of server instances, the at least one second selected server instance satisfying the second abstract definition of server instance characteristics;
assigning, at runtime, the at least one second selected server instance to respond to the second requests from the second originator.

12. A system as in claim 11, wherein the operations further comprise:
detecting a change in availability of one of the at least one second server instances; and
re-assigning one of the at least one server instances to respond to the second requests of the second originator, the re-assigning occurring such that the assigned at least one server instance satisfy the abstract definition and the assigned second at least one server instance satisfy the second abstract definition.

13. A computer-implemented method comprising:
retrieving at least one dynamic logon group parameter associated with an originator of requests for server processing by a computing system comprising a plurality of server instances, the at least one dynamic logon group parameter being established prior to runtime and comprising an abstract definition of server instance characteristics required or preferred for handling the requests from the originator without designating specific server instances for handling the requests from the originator;
selecting at least one server instance from the plurality of server instances, the at least one selected server instance satisfying the abstract definition of server instance characteristics;
assigning, at runtime, the at least one selected server instance to respond to the requests from the originator.

14. A computer-implemented method as in claim 13, wherein the assigned at least one server instance comprises at least two server instances of the plurality of server instances, and wherein operations further comprise distributing a plurality of incoming requests from the originator across the assigned at least two server instances.

15. A computer-implemented method as in claim 13, wherein the computing system is part of a multi-tenant software delivery architecture and the originator comprises a tenant of the multi-tenant software delivery architecture.

16. A computer-implemented method as in claim 15, wherein the multi-tenant software delivery architecture further comprises a data repository, and wherein the computing system provides access for each of a plurality of organizations to one of a plurality of tenants, each of the plurality of tenants comprising a customizable, organization-specific version of a core software platform, the data repository comprising core software platform content that relates to the operation of the core software platform that is common to all of the plurality of tenants, system content having a system content format defined by the core software platform and containing system content data that are unique to specific tenants of the plurality of client tenants, and tenant-specific content items whose tenant-specific content formats and tenant-specific content data are defined by and available to only one of the plurality of tenants.

17. A computer-implemented method as in claim 15, further comprising:
retrieving at least one second dynamic logon group parameter associated with a second originator of second requests for server processing by the computing system, the at least one second dynamic logon group parameter being established prior to runtime and comprising a second abstract definition of server instance characteristics required or preferred for handling the second requests from the second originator without designating second specific server instances for handling the second requests from the second originator;
selecting at least one second server instance from the plurality of server instances, the at least one second selected server instance satisfying the second abstract definition of server instance characteristics;
assigning, at runtime, the at least one second selected server instance to respond to the second requests from the second originator.

18. A computer-implemented method as in claim 17, further comprising:
detecting a change in availability of one of the at least one second server instances; and
re-assigning one of the at least one server instances to respond to the second requests of the second originator, the re-assigning occurring such that the assigned at least one server instance satisfy the abstract definition and the assigned second at least one server instance satisfy the second abstract definition.

19. A computer-implemented method as in claim 17, wherein at least one of the retrieving, the selecting, and the assigning is performed by at least one programmable processor.
